(19) United States
(12) Patent Application Publication
(10) Pub. No.: US 2015/0069185 A1
(43) Pub. Date: Mar. 12, 2015

(54) Cushioned Platform System for Aerial Delivery

(71) Applicants: Stephen T. Parkinson, Suffield, CT (US); Charles R. Sandy, Camden, DE (US)

(72) Inventors: Stephen T. Parkinson, Suffield, CT (US); Charles R. Sandy, Camden, DE (US)

(21) Appl. No.: 14/479,753

(22) Filed: Sep. 8, 2014

Related U.S. Application Data
(60) Provisional application No. 61/875,348, filed on Sep. 9, 2013.

(51) Int. Cl. B64D 1/14; B65D 19/00; B65D 19/40

(52) U.S. Cl. CPC B64D 1/14; B65D 19/40; B65D 19/0002
USPC 244/137.3; 410/46

(57) ABSTRACT

A cushioned platform system and an aerial delivery method employ at least one airbag module. The airbag modules are mounted at the underside of a platform which supports the payload. Parallel roller pads are disposed below the at least one airbag module when the module is in a non-deployed mode and facilitate rolling the platform and payload onto the aircraft. The platform and payload are extracted from the aircraft with an extraction parachute. A mechanism is automatically activated to release the airbag module to a deployed mode prior to impact. The deployed airbag module may be repacked to the non-deployed mode for subsequent usage.

### BACKGROUND

This disclosure relates generally to devices and techniques for reducing shock loading from landing aerial platforms. More particularly, this disclosure relates to devices and techniques for reducing shock loading to payloads mounted on platforms and dropped from military aircraft.

Type V platforms are typically used for aerial delivery of payloads ejected from military cargo aircraft. Such platforms descend by parachute and typically have no intrinsic energy absorption mechanism to reduce landing deceleration. One conventional technique is to add energy dissipating material (EDM) between the payload and the platform to reduce the shock. The deficiency of EDM usage is that it is inconvenient to rig and de-rig. In addition, the resulting shock levels (even when EDM is used) are excessive for some payloads.

The existing systems which employ airbags to reduce shock are not compatible with most military cargo handling and parachute deployment systems. Conventional proposals, which employ pressurized under-platform airbags, are unduly complex, have high maintenance costs and present extra hazards within the aircraft. Proposals, which use pressurized airbags above the platform, do not appear to have any significant advantage over EDM despite the introduction of certain additional hazards. Other proposed systems for reducing load shock employ airbags mounted under type V platforms in combination with hinged trap doors. Either the design has insufficient roller contact for efficient loading, or the design does not have a safe locking and opening system.

A number of proposals inject a vertical acceleration to the platform just before impact. Such systems are relatively complex, have not established a high degree of effectiveness, add considerable weight and significantly reduce reliability.

### SUMMARY

Briefly stated, a cushioned aerial platform comprises a platform assembly having an upper platform for receiving cargo and a lower portion. A pair of parallel outer rails is mounted for partial disposition at the lower portion. A pod of airbag modules is disposed below the lower portion between the outer rails. The airbag modules are configurable in a non-deployed mode and a deployed mode. A pair of parallel inner rails is mounted to the airbag modules and positionable to secure the modules in the non-deployed mode. Securement members on the outer rails are engageable to selectively lock the platform in the cargo hold of an aircraft. A release mechanism is automatically actuatable to permit the airbag modules to deploy. The inner rails drop to transform the airbag modules to a deployed mode upon actuating the release mechanism.

Each airbag module further comprises a lower panel which mounts the inner rails and drops to force the airbag module to deploy upon actuating the release mechanism. Each airbag module comprises a plurality of outlet vents. The outer rails and the inner rails comprise roller pads which are generally co-planar in the non-deployed mode. The automatic release mechanism is preferably a variant of the operating lever of an extraction force transfer coupling (EFTC).

The airbag modules preferably comprise fabric sidewalls and connector members connect between the sidewalls. An extraction parachute is operatively connected to the platform assembly. The airbag modules include airbag vents which provide a partially deflated configuration upon landing. The airbag modules are reconfigurable in the non-deployed mode after assuming the deployed mode.

A cushioned aerial platform comprises a platform assembly having an upper platform for receiving cargo and an underside. A pair of parallel outer rails is mounted for at least partial disposition at the underside. At least one airbag module is disposed below the underside between the outer rails and is configurable in a non-deployed mode and a deployed mode. A pair of parallel inner rails is mounted to at least one said airbag module and is positionable to secure the at least one module in the non-deployed mode. Flange members are engageable to selectively secure the platform in an aircraft. A release mechanism is actuatable to permit said at least one airbag module to deploy. The inner rails drop relative to the platform underside to force the at least one airbag module to deploy upon actuating the release mechanism.

Each airbag module further comprises a lower panel which mounts the inner rails and drops to force the airbag module to a deployed mode upon actuating the release mechanism. Each airbag module includes a plurality of outlet vents. The inner and outer rails comprise elongated roller pads which extend from one end to an opposite end of the platform assembly. An extraction parachute is operatively connected to the platform assembly.

An aerial delivery method comprises loading a payload on a platform and rolling the platform into an aircraft cargo hold. The method further includes locking the platform into a stable position within the aircraft. The method also further comprises extracting the payload and the platform from the aircraft via an extraction parachute and deploy a main parachute suspending the payload and platform for descent. The method also includes automatically deploying at least one airbag module below the platform with the aid of the inner roller pads dropping prior to the landing of the payload and platform.

At least airbag module is repacked in a non-deployed mode after landing of the payload and platform. The platform is at least partially unlatched from the aircraft prior to extracting the payload and the platform. The step of deploying further comprises automatically actuating a mechanical release mechanism.

A retainer is released for said at least one airbag module to allow the airbag module to drop downwardly relative to the platform under the force of gravity. The step of deploying the airbag module further comprises actuating an operating lever similar to the operating lever of an EFTC.

### BRIEF DESCRIPTION OF THE DRAWINGS

FIG. 1 is a generally top perspective view of a cushioned platform as configured in an aircraft;

FIG. 2 is a bottom perspective view of the cushioned platform;

FIG. 3 is an end elevational view of the cushioned platform of FIG. 1;

FIG. 4 is an upper perspective view of the cushioned platform of FIG. 1 in a fully deployed configuration;

FIG. 5 is a bottom perspective view of the cushioned platform in the deployed configuration of FIG. 4;

FIG. 6 is an end elevational view of the cushioned platform in the fully deployed configuration of FIG. 4;

FIG. 7 is an upper perspective view of the cushioned platform of FIG. 1 in a partially compressed configuration;

FIG. 8 is a bottom perspective view of the cushioned platform in the partially compressed configuration of FIG. 7;

FIG. 9 is an end elevational view of the cushioned platform in the partially compressed configuration of FIG. 7;

FIGS. 10A-10C are top perspective views of a representative airbag module in a packed mode, a fully expanded mode and a mode under compression for the cushioned platform in the configuration of FIGS. 1, 4 and 7, respectively;

FIG. 11 is an enlarged fragmentary end perspective view, illustrating a representative lock/release assembly for the airbag modules employed in the cushioned platform;

FIG. 12 is an enlarged fragmentary end perspective view, further illustrating the lock/release assembly of FIG. 11;

FIG. 13 is an enlarged fragmentary top plan view of the decking system and lock/release assembly of FIG. 11 employed in the cushioned platform;

FIG. 14 is an enlarged fragmentary top perspective view of the decking system and lock/release assembly for the cushioned platform of FIG. 11;

FIG. 15 is an elevational view, portions removed and partly in schematic, of a military transport aircraft with a cushioned platform and a representative payload in the form of a vehicle ready for an aerial delivery as viewed from the aft of the aircraft;

FIG. 16 is an enlarged perspective view, partly in diagram form, illustrating the vehicle secured to the top of a cushioned platform and illustrating an extraction line;

FIG. 17 is an enlarged perspective view, partly in diagram form, of a cushioned platform together with a secured vehicle further illustrating a deployment line and suspension slings for a main suspension parachute;

FIG. 18 is an enlarged perspective view, partly in diagram form, from the aft thereof further illustrating the cushioned platform and the vehicle, an extraction line, a deployment line and slings for the platform and vehicle;

FIG. 19 is an enlarged perspective view, partly in diagram form, of the cushioned platform and the vehicle further illustrating the extraction and the deployment lines in diagram form;

FIG. 20 is an enlarged perspective view, partly in diagram form, illustrating the cushioned platform and secured vehicle together with an extraction line and suspension lines;

FIG. 21 is a perspective view of the cushioned platform and secured vehicle, partly in schematic and diagram form, and partly illustrating the deployment line for deploying the suspension parachute; and

FIG. 22 is a perspective view illustrating the cushioned platform and secured vehicle during descent together with the suspension lines for the suspension parachute;

### DETAILED DESCRIPTION

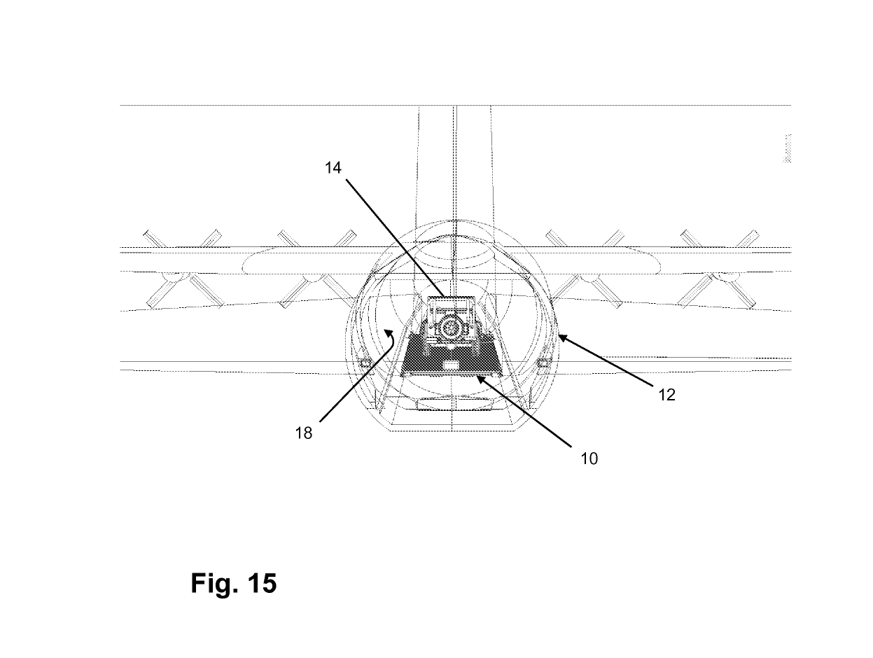

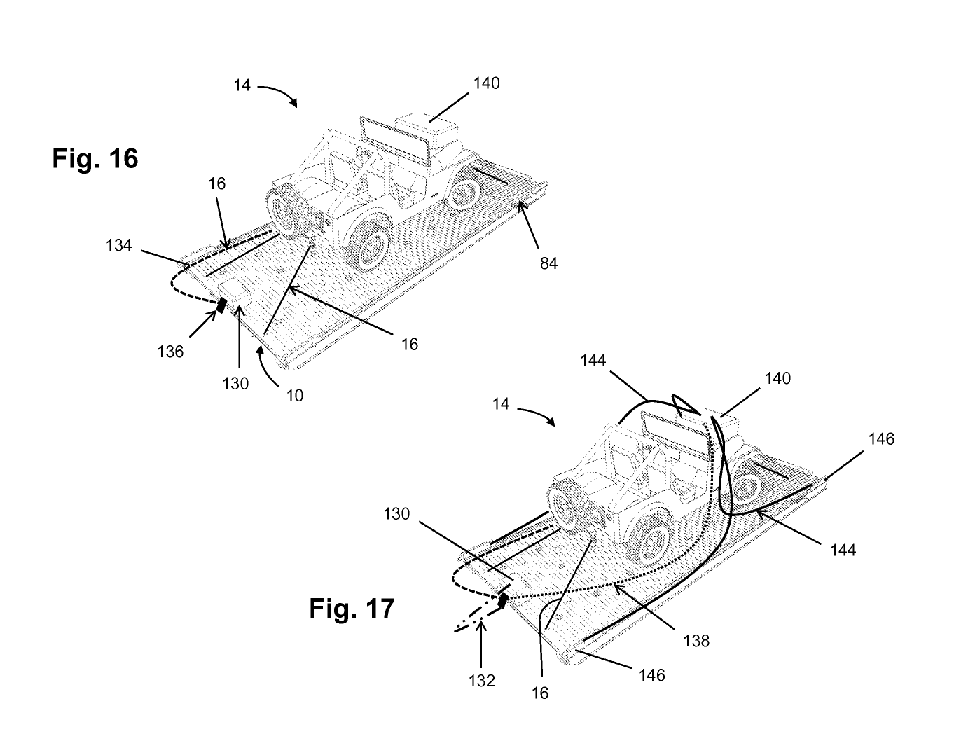

With reference to the drawings wherein like numerals represent like parts throughout the several figures, a cushioned platform is generally designated by the numeral 10. With reference to FIGS. 15 and 16, the cushioned platform is particularly adapted for aerial delivery of secured cargo or a payload via a military aircraft 12. A representative payload 14, such as a vehicle, is rolled, driven or otherwise placed onto the platform in a conventional manner and retained in place by conventional securement techniques, such as tie-down chains or securement cables 16. The entire payload plus the platform is then loaded onto the aircraft, rolled over rollers into the cargo hold 18 and locked into a stable position with the aircraft cargo handling system in the cargo hold 18.

The airborne aircraft 12 with the cushioned platform and payload approaches the delivery zone. The cushioned platform 10 with the payload 14 is then extracted from the aircraft by an extraction parachute 130 and delivered by a main suspension parachute 140. An integrated cushioned system, as described below, which features airbags is automatically deployed during descent to cushion the landing of the loaded platform. The cushioned platform 10 with the airbag cushioned system is reusable for subsequent aerial delivery.

The platform 10 comprises an upper receiving surface or deck 20 of conventional form and function which longitudinally extends between ends 22 and 24. A starboard extruded rail 30 extends the longitudinal length of the platform and a transversely opposite port extruded rail 40 also extends the longitudinal length of the platform. The starboard and port rails 30 and 40, respectively, include a lower elongated roller pad 32 and 42. The starboard rail includes upwardly protruding flanges 34 and 36 with cutouts which interface with the cargo handling system. Likewise, the port rail has upwardly protruding flanges 44 and 46 which interface with the aircraft cargo handling system. The flanges 34, 36, 44 and 46 lock the platform upwards, outwards, fore and aft in a stable position in the cargo hold 18 of the aircraft.

A pod 48 of substantially identical airbag modules 50 in compact non-deployed packed form are mounted in a linear arrangement at the underside of the platform between the outboard and inboard rails 30 and 40. The airbag module 50 may assume several forms and include one or more airbags. Each airbag module 50 is representative of various possible embodiments.

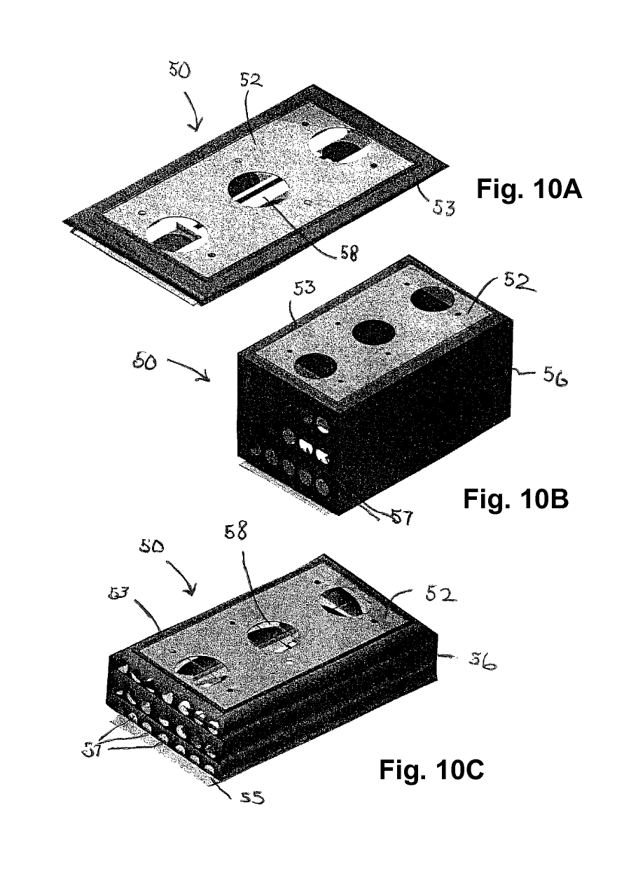

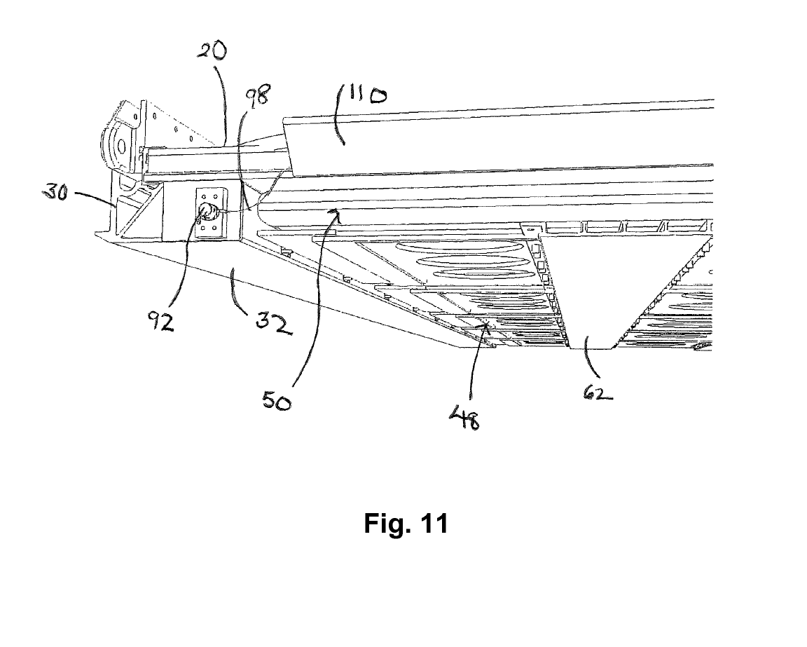

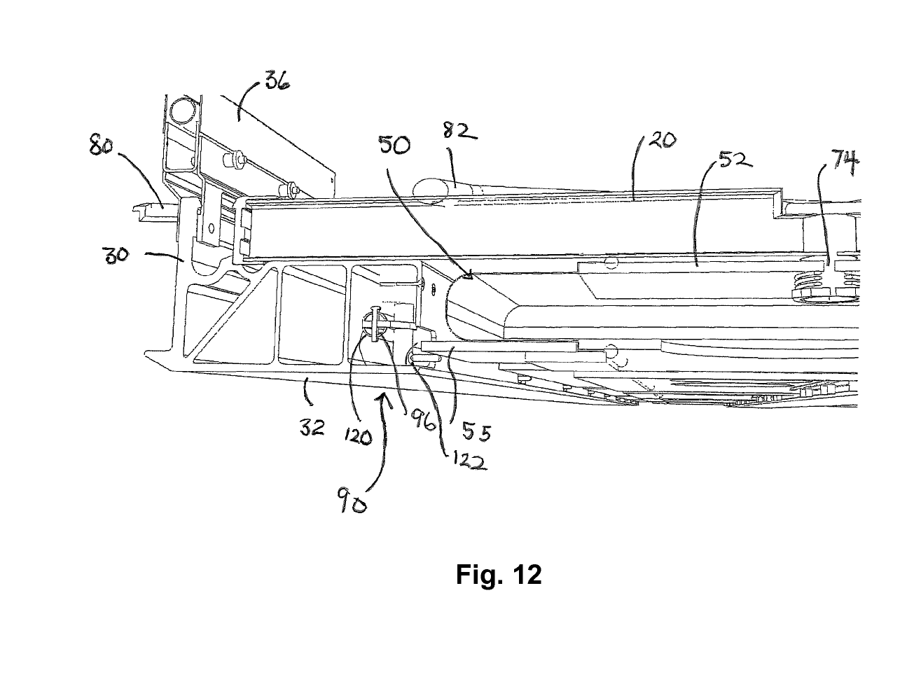

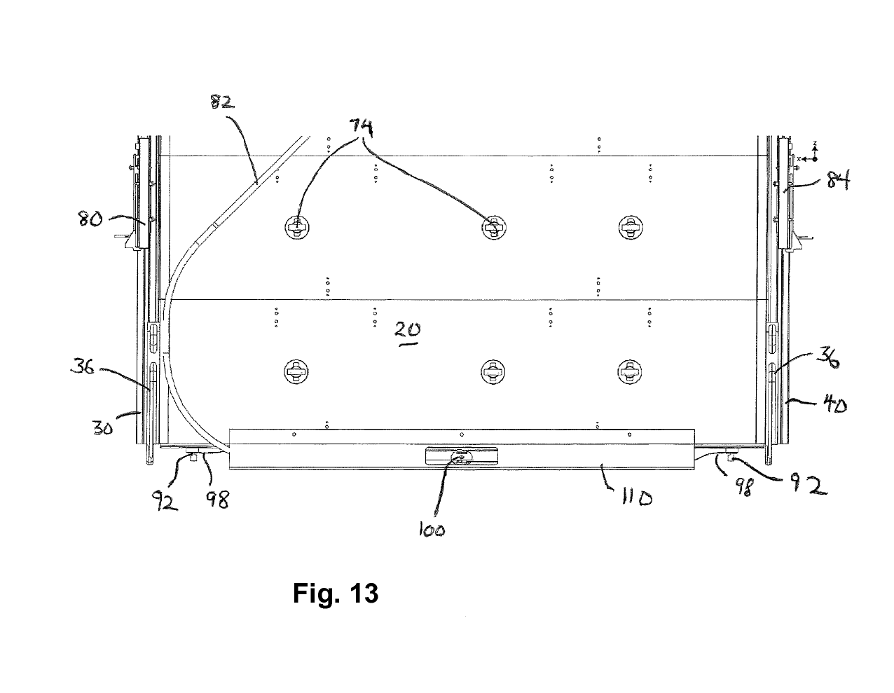

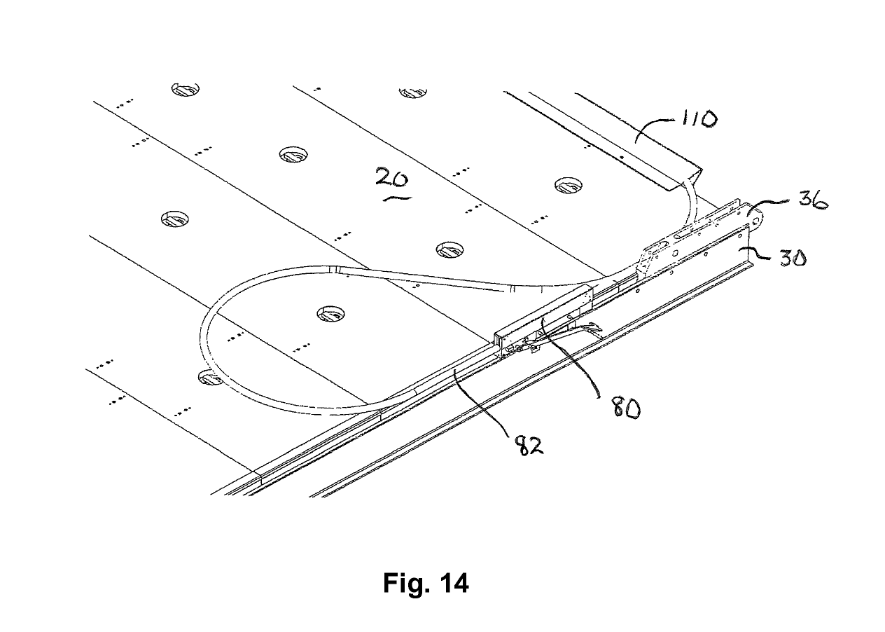

With additional reference to FIGS. 10A-10C, each airbag module 50 employs a top panel 52 which is connected by a bottom panel 54 and an intermediate circumferential sidewall 56 of fabric material. The panels 52 and 54 may have flange-like frames 53 and 55, respectively. In one embodiment, internal catenaries (not illustrated) and cables (not illustrated) may be employed to connect to distribute the load and shape the circumferential sidewall so that the sidewall inflates substantially uniformly. A support skeleton 58 (visible through access openings in panel 52 of FIGS. 10A and 10C) is preferably disposed within the airbag module. The function of the support skeleton 58 is to provide a load path between the payload and the central roller trays in the aircraft. This maximizes load carrying capability of the platform by distributing load to all four aircraft roller trays. Aircraft roller load limit is one of the restrictions on platform payload capacity. The skeleton 58 is attached to the lower panel 54 only, permitting both a single airbag module across the width of the platform yet maintain a load path to all four roller trays when the platform is in the aircraft. The inflatable element includes outlet vents 57. In one embodiment, there are 36 outlet vents 57, although the number and dimensioning of the vents may vary. The bottom panel includes inlet vents 59 which may also provide access to the interior of the airbag module for inflation.

Each airbag module 50 has a packed, non-deployed configuration of FIG. 10A which is ultimately deployed to an expanded, fully inflated configuration of FIG. 10B and, upon landing or deceleration, the partially compressed configuration FIG. 10C. The outlet vents 57 are dimensioned and configured to selectively control the compressed configuration. In one embodiment, each module has a length of approximately four feet and upon expansion, extends approximately thirty-six inches in height.

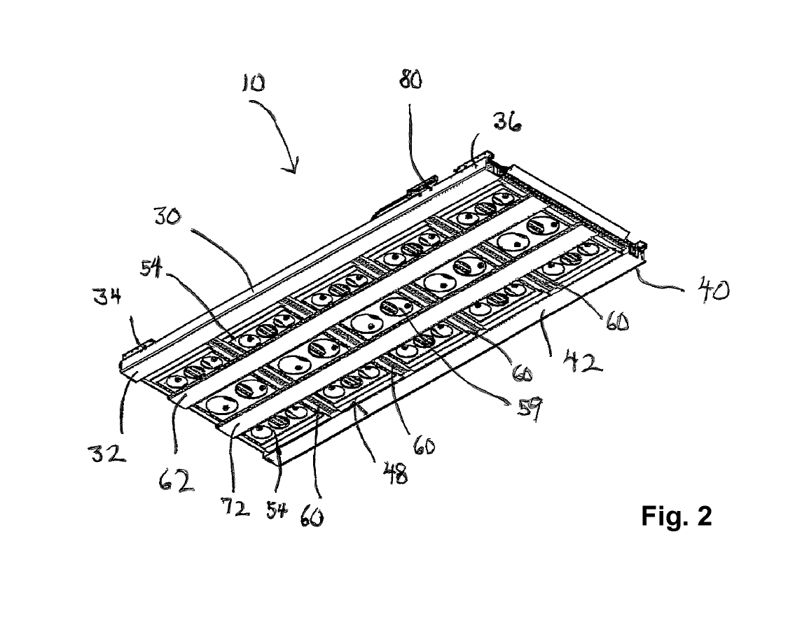

Spaced transversely extending supports 60 optionally mount over the interface of adjacent airbag modules 50 at the underside of the platform. The supports and/or bottom panels 54 mount a pair of parallel spaced, elongated roller pads 62 and 72. In one embodiment, the supports 60 or roller pads 62 and 72 are internally supported by the support skeleton 58 within the airbag module. Roller pads 62 and 72 are parallel to the roller pads 32 and 42 and, in the aircraft configuration of FIG. 2, are generally coplanar therewith. It will be appreciated that in the aircraft configuration, the platform is compatible for rolling on the conventional four rolls of rollers typically provided in the aircraft cargo hold 18. The support skeleton 58 supports the roller pads 62 and 72. Locks 74 secure the upper panel 52 to the platform deck 20.

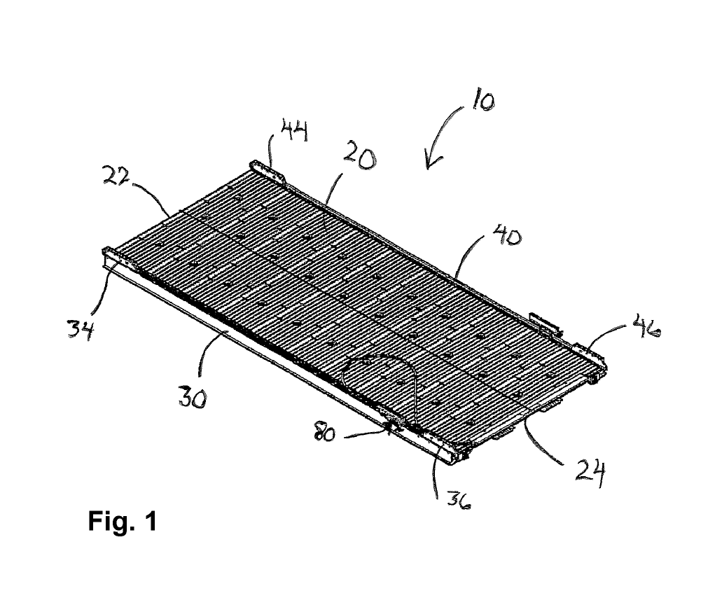

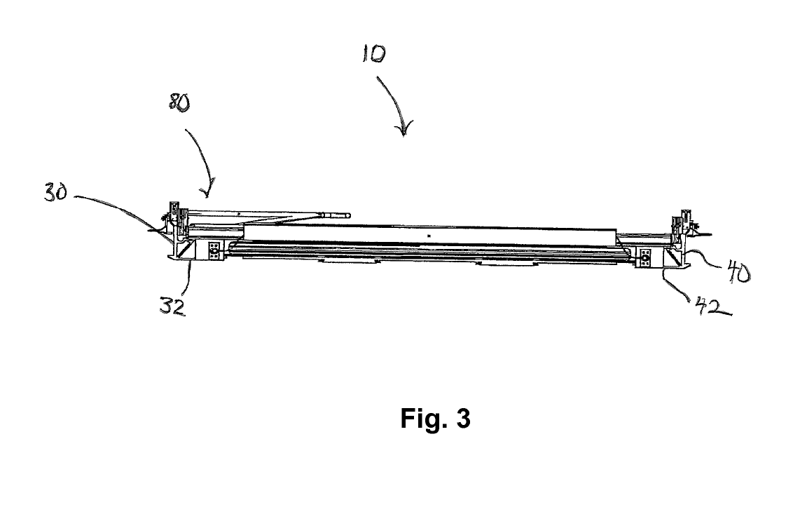

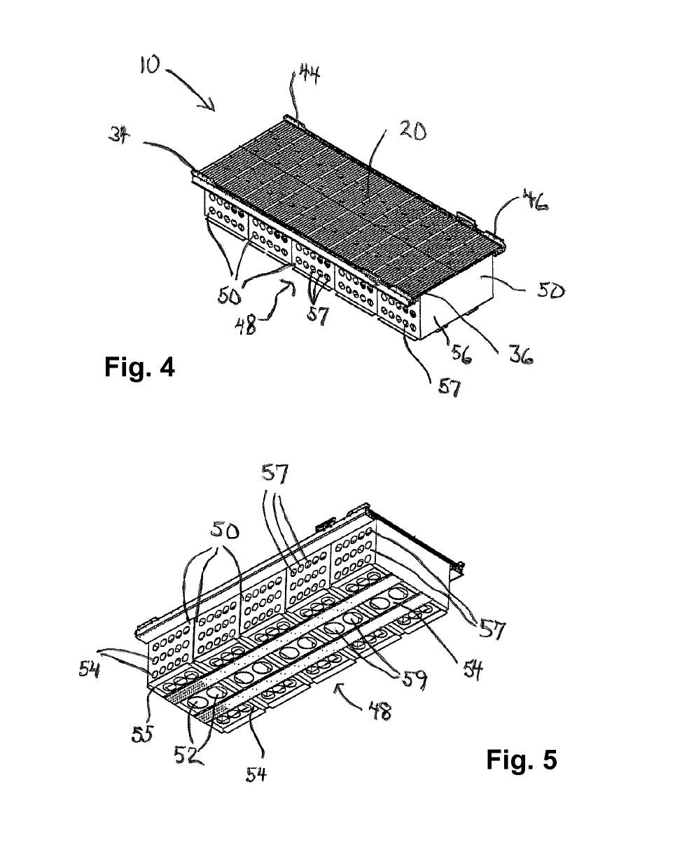

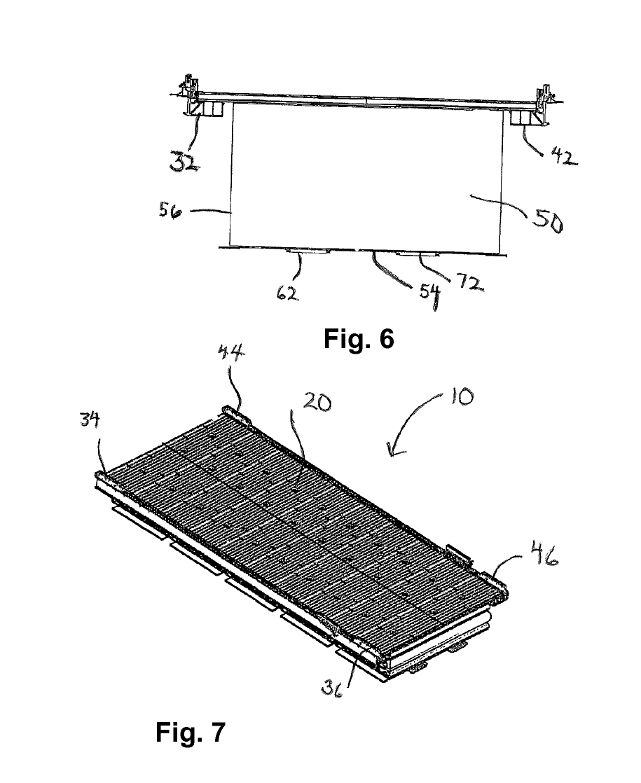

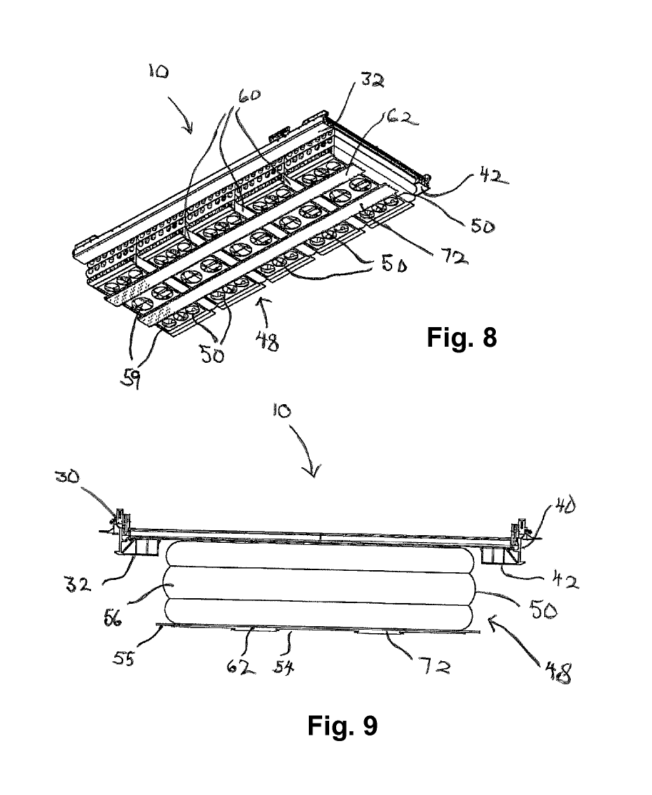

With reference to FIGS. 1 and 3, an operating lever 80 similar to the operating lever of an EFTC is mounted to the rail 30. The operating lever 80 connects with a cord or cable for deploying the airbag modules 50 as described below.

The airbag modules 50 may be retained to the underside of the platform by various means and are preferably released concurrently for deployment. In one embodiment, a spring-loaded flange-like lever lock/release assembly 90 retains the pod of airbag modules 50 in a non-deployed state at the underside of the platform. For some embodiments, multiple retention lock/release assemblies (not illustrated) are employed. A pin 92 at the port and starboard may extend through a portion of a spring shaft 96 and connect via ripcords 98 to a pulley 100. The pulley is rotated by actuation of the operating lever 80 on a cable 82 and a mirror EFTC-like operating lever 84 connected to the pulley 100. All of the lever/lock releases 90 are thereby concurrently released. The operating lever functions as a sprung lever once the platform is out of the aircraft. The pulley/cable assemblies are housed in an elongated nose-piece 110 at the end of the platform. An actuating rod 120 connects all the lever locks 122 on each side of the platform. The lever locks pivot to release the flange 55 on the airbag module.

Ultimately in another embodiment, releasable locks are only provided on one side of the assembly. Other means for releasing the bottom panel to allow it to descend are also possible.

When the EFTC-like operating lever 80 is released, each lock/release assembly 90 is released. In addition, the mass of the supports 60 and the mounted roller pads 62 and 72 pull or otherwise force the airbags 50 downward by gravity. The airbags inflate during descent.

The cushioned platform 10 in the configuration of FIGS. 1-3 receives the payload and the cushioned platform 10 is rolled over the rollers (not illustrated) on the four roller pads 32, 42, 62 and 72 to the proper position within the aircraft hold. The platform is locked into place in the hold 18 by the flanges 34, 36, 44 and 46. The outer and the inner roller pads 32, 42, 62 and 72 slidably engage the four parallel lines of rollers in the aircraft.

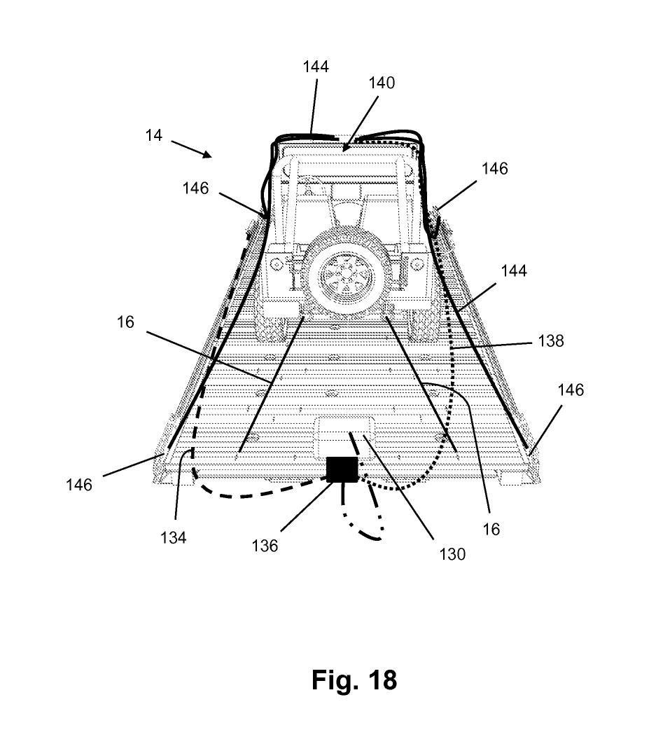

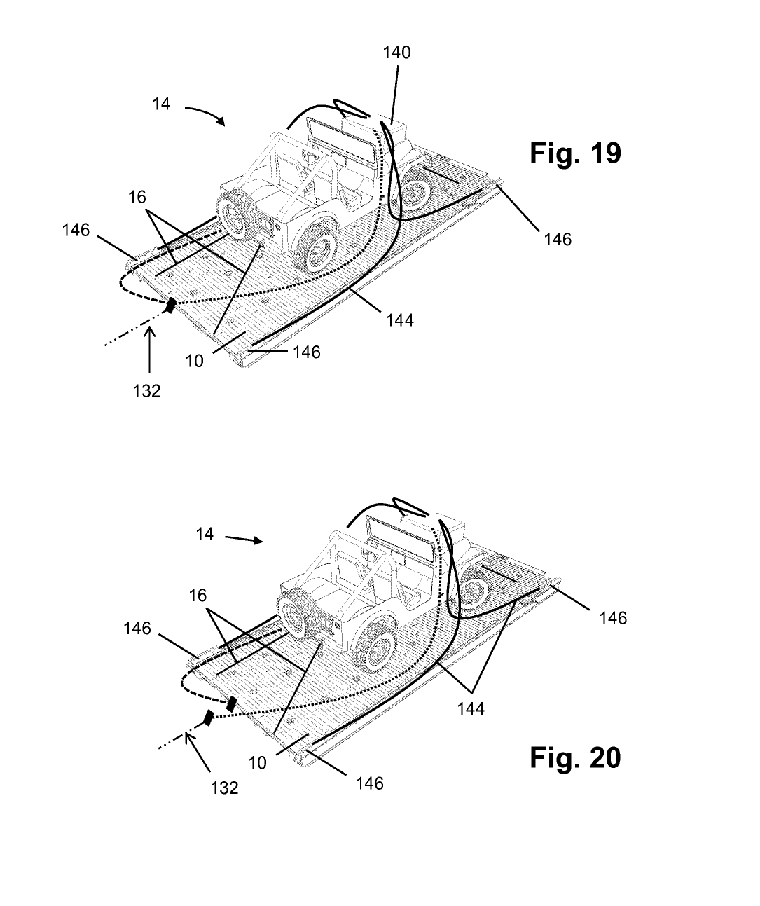

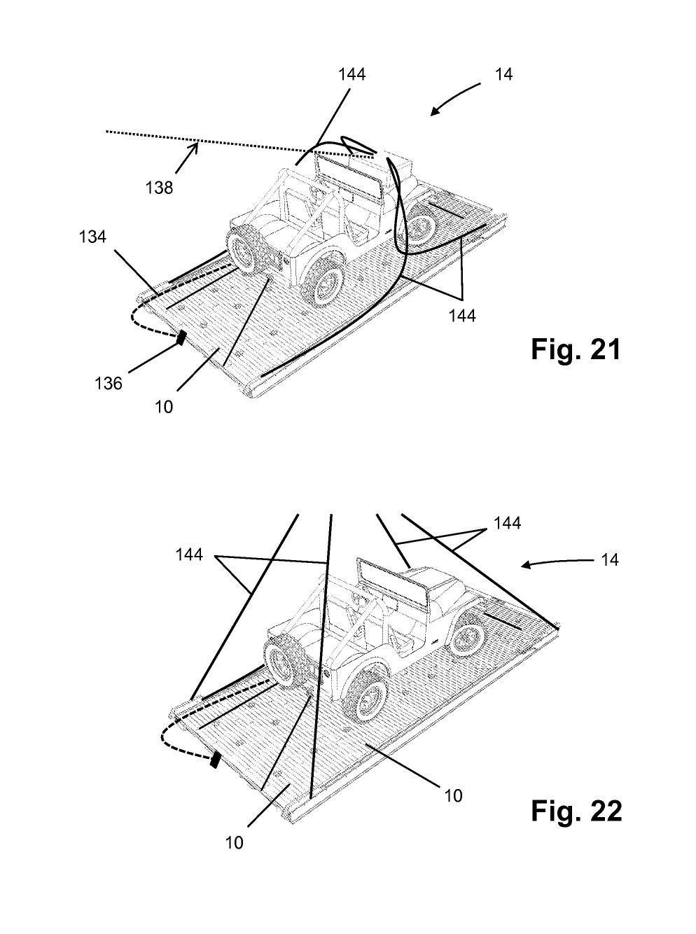

With additional reference to FIGS. 15-22, during the aerial delivery, the forward aft latches on the port side are disengaged. The extractor parachute 130 is activated. The force generated by the extractor parachute via the extraction line 132 (FIG. 17) overcomes the preload of the fore and aft latches on the starboard side of the aircraft. The cushioned platform 10 is then pulled out of the aircraft. An EFTC actuating cable 134 (FIG. 16) activates an EFTC latch 136 to disconnect the extractor parachute 130 from the platform.

Upon extraction, an EFTC coupling (not illustrated) releases a deployment line 138 and initiates the transition from the extractor parachute to the main suspension parachute 140. The deployment line 138 tenses and triggers the opening sequence of the main parachute 140. The parachute bag is pulled off of the main parachute 140. Four suspension slings 144 are attached to tandem fore and aft links 146 on the platform 10. The suspension slings 144 tense as the parachute deploys.

As the cushioned platform 10 descends, once the platform sufficiently slows, the airbag modules 50 are then deployed. The deployment is accomplished by a mechanical release of the bottom structure of the airbag modules 50. Preferably, the mechanical release is initiated by the operating lever 80 and a mirror operating lever 84 with a delay. Alternatively, a lazy leg with delay from the main parachute cluster may also be employed. The airbag modules 50 essentially deploy by gravity. The mass of the center roller pads 62 and 72 and the supports 60 pull or force open the airbag modules 50 for inflation of the sidewalls. During descent, air fills and inflates the airbags.

Upon landing, the inlet vents seal 59 and the airbag modules pressurize. Outlet vents 57 are dimensioned to provide a reaction force to progressively slow the platform. Upon landing, the payload is released by disconnecting the various securement hardware including cables 16. The complete cushioned platform can then be retrieved and repacked to the non-deployed configuration of FIG. 2.

Various adjustments can be implemented for the cushioned platform. For example, one or more airbags may be eliminated. In addition, the throttle on the outlet vents 57 may be modified to provide the proper cushioning for a given payload.

It will be appreciated that the cushioned platform 10 provides a very efficient storage of the airbags and a very efficient deployment when needed. The continuous roller pads 62 and 72 are employed to link the separate airbag modules together to ensure that they open together. In addition, the roller pads add mass to facilitate deployment of the airbag modules. The roller pads 62 and 72 also provide a continuous surface upon installation or extraction to prevent jamming between the separate airbag modules. The roller pads 62 and 72 also function to facilitate loading the platform 10 in the cargo hold 18 by providing a rolling surface for the rollers. Of course, the airbag system can be configured to adjust the venting to accommodate a reduced and a concentrated payload.

While preferred embodiments of the foregoing cushioned platform assembly have been set forth for purposes of description, the foregoing should not be deemed a limitation of the invention herein. Accordingly, various modifications, adaptations and alternatives may occur to one skilled in the art without departing from the spirit and the scope of the present invention.

1. A cushioned aerial platform comprising:
a platform assembly having an upper platform for receiving cargo and a lower portion;
a pair of parallel outer rails mounted to said platform assembly;
a pod of airbag modules disposed below said lower portion between said outer rails and configurable in a non-deployed mode and a deployed mode;
a pair of parallel inner rails mounted to said airbag modules and positionable to secure the modules in the non-deployed mode;
securement members on said outer rails engageable to selectively lock said platform assembly in an aircraft;
a release mechanism automatically actuatable to transform said airbag modules to a deployed mode,
wherein said inner rails drop when said airbag modules are transformed to the deployed mode upon actuating said release mechanism.

2. The cushioned aerial platform of claim 1 wherein each airbag module further comprises a lower panel which mounts said inner rails and drops to transform said airbag module to a deployed mode upon actuating said release mechanism.

3. The cushioned aerial platform of claim 1 wherein each airbag module comprises a plurality of outlet vents.

4. The cushioned aerial platform of claim 1 wherein said outer rails and said inner rails comprise roller pads which are generally co-planar in the non-deployed mode.

5. The cushioned aerial platform of claim 1 wherein said release mechanism comprises an operating lever.

6. The cushioned aerial platform of claim 1 wherein said airbag modules comprise fabric sidewalls and connector members connect between said sidewalls.

7. The cushioned aerial platform of claim 1 further comprising an extraction parachute operatively connected to said platform assembly.

8. The cushioned aerial platform of claim 1 wherein said airbag modules include airbag vents which provide a partially deflated configuration upon landing.

9. The cushioned aerial platform of claim 1 wherein said airbag modules are reconfigurable in the non-deployed mode after assuming the deployed mode.

10. A cushioned aerial platform comprising:
a platform assembly having an upper platform for receiving cargo and an underside;
a pair of parallel outer rails mounted for at least partial disposition at said underside;
at least one airbag module disposed below said underside between said outer rails and configurable in a non-deployed mode and a deployed mode;
a pair of parallel inner rails mounted to at least one said airbag module and positionable to secure the at least one module in the non-deployed mode;
a plurality of flange members engageable to selectively secure said platform assembly in an aircraft;
a release mechanism actuatable to transform said at least one airbag module to a deployed mode,
wherein said inner rails drop relative to said underside when said at least one airbag module is transformed to a deployed mode upon actuating said release mechanism.

11. The cushioned aerial platform of claim 10 wherein each airbag module further comprises a lower panel which mounts said inner rails and drops to transform said airbag module to a deployed mode upon actuating said release mechanism.

12. The cushioned aerial platform of claim 10 wherein each airbag module comprises a plurality of outlet vents.

13. The cushioned aerial platform of claim 10 wherein said inner and outer rails comprise elongated pads which substantially extend from one end to an opposite end of the platform assembly and are generally co-planar in the non-deployed mode.

14. The cushioned aerial platform of claim 10 further comprising an extraction parachute operatively connecting said platform assembly.

15. An aerial delivery method comprising:
loading a payload on a platform having a pair of inner rails;
rolling the platform over rollers engaging said inner rails into an aircraft cargo hold;
locking the platform in a stable position within the aircraft;
extracting the payload and the platform from the aircraft by an extraction parachute;
suspending the payload and the platform from a main suspension parachute for descent; and
deploying at least one airbag module after extracting the platform and prior to landing of the payload and platform by automatically releasing a panel and the pair of inner rails from below the platform so that they drop relative to the platform.

16. The aerial delivery method of claim 15 further comprising packing said at least one airbag module in a non-deployed mode after landing of the payload and platform.

17. The aerial delivery method of claim 15 further comprising at least partially unlatching the platform from the aircraft prior to extracting the payload and the platform.

18. The aerial delivery method of claim 15 further comprising wherein the step of deploying at least one airbag module further comprises automatically actuating a mechanical release mechanism.

19. The aerial delivery method of claim 15 further comprising releasing a retainer of said at least one airbag module and allowing said airbag module to drop downwardly relative to said platform under the force of gravity.

20. The aerial delivery method of claim 15 wherein said the step of deploying further comprises actuating a lever.
